(19) United States
(12) Patent Application Publication
(10) Pub. No.: US 2026/0179573 A1
(43) Pub. Date: Jun. 25, 2026

(54) DISPLAY DEVICE, METHOD OF DRIVING THE DISPLAY DEVICE, AND ELECTRONIC DEVICE INCLUDING THE DISPLAY DEVICE

(71) Applicant: Samsung Display Co., Ltd., Yongin-Si (KR)

(72) Inventors: Kyung Man KIM, Yongin-si (KR); HYEJI KIM, Yongin-si (KR)

(21) Appl. No.: 19/238,524

(22) Filed: Jun. 16, 2025

(30) Foreign Application Priority Data
Dec. 20, 2024 (KR) 10-2024-0193338

(51) Int. Cl. G09G 3/3291

(52) U.S. Cl. CPC G09G 3/3291; G09G 2300/0842; G09G 2310/08; G09G 2320/0233; G09G 2320/041

(57) ABSTRACT

A display device according to an embodiment may include a display panel that includes a plurality of pixels, a data driver that receives sequentially a plurality of input data signals, and applies data voltages, corresponding to a first input data signal of the plurality of input data signals, to the plurality of pixels, a sensing driver that senses pixel current flowing in the plurality of pixels as the data voltages are applied to the plurality of pixels, and generates first sensing data on a basis of the pixel current, and a timing controller that generates first compensation data by compensating a second input data signal, subsequent to the first input data signal among the plurality of input data signals, using at least one of initial sensing data and the first sensing data on a basis of the drive time of the display device.

### CROSS-REFERENCE TO RELATED APPLICATION

This application claims priority to and the benefit of Korean Patent Application No. 10-2024-0193338 filed with the Korean Intellectual Property Office on Dec. 20, 2024, the entire contents of which are incorporated herein by reference.

### BACKGROUND

### (a) Field

The present disclosure relates to a display device, a method of driving the display device, and an electronic device including the display device.

### (b) Description of the Related Art

An organic light emitting diode (OLED) display device may include pixels, each of which includes an OLED which is a light emitting device, and a driving thin film transistor (TFT). The pixels are arranged in the form of a matrix and adjust the luminance of an image realized according to gray level of video data. The driving TFT controls pixel current flowing in an OLED according to the voltage applied by a gate electrode to an active layer located between a source electrode and a drain electrode. The amount of light emitted by each OLED depends on its pixel current, and luminance of an image depends on the amount of light emitted by the OLEDs.

When a driving TFT operates in a saturation region, the pixel current that flows between the drain and source of the driving TFT may vary depending on electrical characteristics of the driving TFT such as threshold voltage and electron mobility. Even if the same data voltage is applied to the pixels, luminance deviations may occur between the pixels. The luminance of an image may also be affected by various external factors such as a temperature change in the display panel.

### SUMMARY

The present disclosure may provide a display device having uniform luminance.

Also, the present disclosure may provide a display device capable of being driven at low power.

A display device according to an embodiment may include a display panel that includes a plurality of pixels, a data driver that receives sequentially a plurality of input data signals, and applies data voltages, corresponding to a first input data signal of the plurality of input data signals, to the plurality of pixels, a sensing driver that senses pixel current flowing in the plurality of pixels as the data voltages are applied to the plurality of pixels, and generates first sensing data on a basis of the pixel current, and a timing controller that generates first compensation data by compensating a second input data signal, subsequent to the first input data signal among the plurality of input data signals, using at least one of initial sensing data and the first sensing data on a basis of a drive time of the display device.

A method of driving a display device according to an embodiment may include a step of receiving sequentially a plurality of input data signals and applying a data voltage, corresponding to a first input data signal of the plurality of input data signals, to a plurality of pixels, a step of generating first sensing data by sensing pixel current flowing in a driving transistor included in each of the plurality of pixels, and a step of generating first compensation data by compensating a second input data signal, subsequent to the first input data signal among the plurality of input data signals, using at least one of initial sensing data and the first sensing data on a basis of a drive time of the display device.

An electronic device according to an embodiment may include a display module that generates compensation data by compensating an input data signal using at least one of initial sensing data and existing sensing data on the basis of a drive time, one or more processors that transmits an input data signal to the display module, a memory that contains initial sensing data which is sensing data that the display module outputs in response to a preset data signal in a state in which an external environmental temperature of the display module is set to a predetermined value, and existing sensing data which is sensing data that the display module has output in a previous frame, and a power module that supplies power to the display module and the processor.

According to embodiments, the process by which input signal data is compensated may vary depending on the drive time of the display device. Accordingly, the input signal data can be precisely compensated.

Further, according to the embodiments, only some of the plurality of sensing lines may be used. Accordingly, the display device can be driven at low power.

### BRIEF DESCRIPTION OF THE DRAWINGS

FIG. 1 is a block diagram of a display device according to an embodiment.

FIG. 2 is a view illustrating some components of the display device according to an embodiment.

FIG. 3 is a view illustrating a frame of the display device according to an embodiment.

FIG. 4 is a view illustrating a display panel according to an embodiment.

FIG. 5 is a graph illustrating temperature error according to the drive time of the display device according to an embodiment.

FIG. 6 is a circuit diagram illustrating a timing controller, a data driver, a sensing driver, and a pixel according to an embodiment.

FIG. 7 is a timing diagram illustrating a change in data voltage, which is applied to a gate of a driving transistor, depending on a drive time according to an embodiment.

FIG. 8 is a flow chart illustrating a method of driving the display device according to an embodiment.

FIG. 9 is a flow chart illustrating STEP S830 of FIG. 8.

FIG. 10 is a flow chart illustrating STEP S850 of FIG. 8.

FIG. 11 is a block diagram of an electronic device according to an embodiment.

FIGS. 12, 13, and 14 are schematic diagrams of electronic devices according to various embodiments.

### DETAILED DESCRIPTION OF THE EMBODIMENTS

In the following detailed description, embodiments of the present inventive concept have been shown and described, simply by way of illustration. As those skilled in the art would realize, the described embodiments may be modified in various different ways, all without departing from the spirit or scope of the present inventive concept.

Accordingly, the drawings and description are to be regarded as illustrative in nature and not restrictive. Like reference numerals designate like elements throughout the specification. In the flow charts described with reference to the drawings, the order of operations may be changed, and several operations may be combined, and an operation may be divided, and some operations may not be performed.

Further, expressions written in the singular forms can be comprehended as the singular forms or plural forms unless clear expressions such as “a”, “an”, or “single” are used. Terms including an ordinal number, such as first and second, are used for describing various constituent elements, but the constituent elements are not limited by the terms. The terms are used only to discriminate a constituent element from other constituent elements.

Hereinafter, the present disclosure will be described in more detail through examples. These examples are just for illustrating the present disclosure, and the right protection scope of the present disclosure is not limited by the examples.

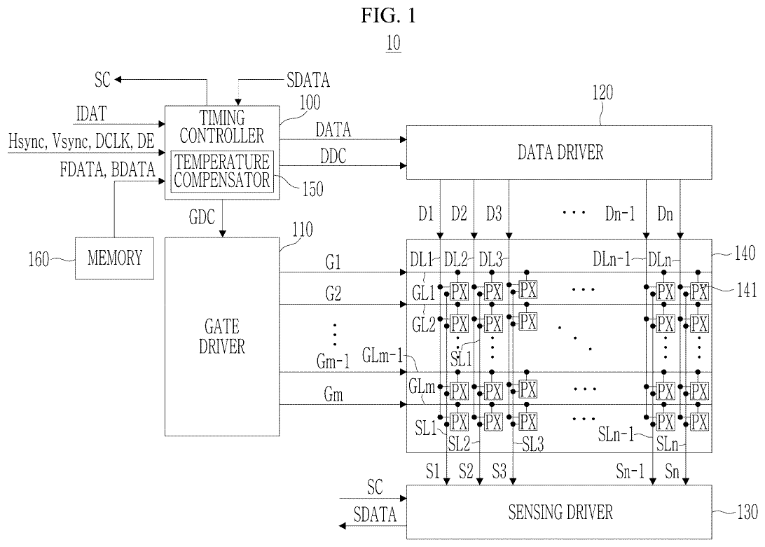

FIG. 1 is a block diagram of a display device according to an embodiment.

Referring to FIG. 1, a display device 10 may display two-dimensional or three-dimensional images to a user. In some embodiments, the display device 10 may be a device in which display driver circuits 100, 110, 120, and 130, and a display panel 140 are implemented as a module. For example, the display driver circuits 100, 110, 120, and 130 may be mounted on a substrate of the display panel 140, or the display driver circuits 100, 110, 120, and 130 and the display panel 140 may be electrically connected through a connection member such as a flexible printed circuit board (FPCB).

The display device 10 may perform a normal mode in which data signals D1, D2, D3, . . . , Dn-1, and Dn are applied to pixels 141, and a sensing mode for sensing current of the pixels 141. When the display device 10 operates in the normal mode, it may display an image corresponding to an input data signal IDAT. When the display device 10 performs the sensing mode, a timing controller 100 may compensate image data corresponding to the input data signal IDAT on the basis of sensing data SDATA generated by a sensing driver 130, thereby generating compensation data DATA.

The display device 10 may include the timing controller 100, a gate driver 110, a data driver 120, the sensing driver 130, and the display panel 140.

The timing controller 100 may receive a vertical synchronization signal Vsync, a horizontal synchronization signal Hsync, and a data enable signal DE. On the basis of the vertical synchronization signal Vsync, the horizontal synchronization signal Hsync, and the data enable signal DE, the timing controller 100 may generate a gate timing control signal GDC, a data timing control signal DDC, and a sensing timing control signal SC.

The timing controller 100 may transmit the gate timing control signal GDC to the gate driver 110. The gate timing control signal GDC may control the operation timing of the gate driver 110.

The timing controller 100 may transmit the data timing control signal DDC and the compensation data DATA to the data driver 120. The data timing control signal DDC may control the operation timing of the data driver 120. The data driver 120 may capture the compensation data DATA on the basis of the data timing control signal DDC.

The timing controller 100 may transmit the sensing timing control signal SC to the sensing driver 130. The sensing timing control signal SC may control the operation timing of the sensing driver 130.

The timing controller 100 may receive sequentially the input data signal IDAT from outside the display device. The input data signal IDAT is data to be written in a plurality of pixels 141, and may refer to data which is an object of compensation.

The timing controller 100 may receive sensing data SDATA from the sensing driver 130. The sensing data SDATA may refer to data calculated from the current of the plurality of pixels 141 sensed in real time.

The display panel 140 may include a heat shielding film such as a metal oxide film or a graphene layer. The heat shielding film or the graphene layer may block heat generated from the external environment temperature from penetrating into the display panel 140. The display panel 140 may include a plurality of signal lines, for example, a plurality of gate lines GL1, GL2, GL3, . . . , GLn-1, and GLn, a plurality of data lines DL1, DL2, DL3, . . . , DLn-1, and DLn, and a plurality of sensing lines SL1, SL2, SL3, . . . , SLn-1, and SLn. The display panel 140 may include a plurality of pixels 141 which is connected to the plurality of signal lines and arranged in the form of a matrix.

The plurality of gate lines GL1, GL2, GL3, . . . , GLn-1, and GLn may extend in a first direction, and each may be connected to a plurality of pixels 141 arranged in the first direction. The plurality of data lines DL1, DL2, DL3, . . . , DLn-1, and DLn may extend in a second direction intersecting the first direction, and each may be connected to a plurality of pixels 141 arranged in the second direction. The plurality of sensing lines SL1, SL2, SL3, . . . , SLn-1, and SLn may extend in the second direction intersecting the first direction, and each may be connected to a plurality of pixels 141 arranged in the second direction.

The gate driver 110 may generate scan signals G1, G2, G3, . . . , Gn-1, and Gn on the basis of the gate timing control signal GDC. The gate driver 110 may provide the scan signals G1, G2, G3, . . . , Gn-1, and Gn to the plurality of gate lines GL1, GL2, GL3, . . . , GLn-1, and GLn. The scan signals G1, G2, G3, . . . , Gn-1, and Gn may be signals for activating the plurality of pixels 141, respectively, to apply the data signals D1, D2, D3, . . . , Dn-1, and Dn to the plurality of pixels 141.

In another embodiment, the gate driver 110 may generate sensing signals S1, S2, S3, . . . , Sn-1, and Sn on the basis of the gate timing control signal GDC. The gate driver 110 may provide the sensing signals G1, G2, G3, . . . , Gn-1, and Gn to the plurality of gate lines GL1, GL2, GL3, . . . , GLn-1, and GLn. The sensing signals S1, S2, S3, . . . , Sn-1, and Sn may be signals for sensing the current flowing in the plurality of pixels 141 to measure an electron mobility of the driving transistors included in the plurality of pixels 141.

The data driver 120 may convert the compensation data DATA into data voltages for image display on the basis of the data timing control signal DDC. The data driver 120 may sequentially receive the compensation data DATA corresponding to a plurality of input data signals IDAT through the timing controller 100. The data driver 120 may generate data transmission signals D1, D2, D3, . . . , Dn-1, and Dn on the basis of the compensation data DATA. The data driver 120 may provide the data transmission signals D1, D2, D3, . . . , Dn-1, and Dn to the plurality of data lines DL1, DL2, DL3, . . . , DLn-1, and DLn. For example, the data driver 120 may apply a data voltage, corresponding to a first input data signal among the plurality of input data signals IDAT, as the data transmission signals D1, D2, D3, . . . , Dn-1, and Dn to the plurality of pixels.

The sensing driver 130 may sense an electrical characteristic of the driving transistor included in each of the plurality of pixels 141 on the basis of the sensing timing control signal SC. The electrical characteristic of the driving transistor may include the mobility of the driving transistor. The electrical characteristic of the driving transistor may vary depending on time-dependent degradation, the temperature of the display panel 140, and the environmental temperature. The environmental temperature may include the temperature of constituent elements disposed outside the display panel 140. For example, the environmental temperature may be temperature attributable to the timing controller 100, the printed circuit board (PCB) substrate, and so on in the display device 10.

The sensing driver 130 may sense the pixel current flowing in the plurality of driving transistors on the basis of the sensing timing control signal SC. The pixel current of the plurality of driving transistor may be transferred as the sensing signals S1, S2, S3, . . . , Sn-1, and Sn to the sensing driver 130 through the sensing lines SL1, SL2, SL3, . . . , SLn-1, and SLn.

The sensing driver 130 may generate sensing data SDATA by performing analog-to-digital conversion on the sensing signals S1, S2, S3, . . . , Sn-1, and Sn. The sensing driver 130 may transmit the sensing data SDATA to the timing controller 100.

The sensing driver 130 may generate a control signal for controlling a plurality of switches included in the sensing driver 130, on the basis of the sensing timing control signal SC.

A memory 160 may be implemented with a non-volatile memory device such as an NND flash, a resistive memory, etc. The memory 160 may store initial sensing data FDATA and existing sensing data BDATA. The initial sensing data FDATA may be sensing data SDATA which the sensing driver 130 outputs when the data driver 120 applies preset data signals D1, D2, D3, . . . , Dn-1, and Dn to the display panel 140. In this case, the environmental temperature of the display device 10 may be set to a preset value. The environmental temperature may refer to the temperature of the external constituent elements of the display panel 140. The existing sensing data BDATA may be sensing data SDATA which the sensing driver 130 outputs when the preset data signals D1, D2, D3, . . . , Dn-1, and Dn were applied to the display device 10 during the sensing operation of the sensing driver 130 with respect to the previous frame. The timing controller 100 may read the initial sensing data FDATA and the existing sensing data BDATA from the memory 160.

The timing controller 100 may compensate a second input data signal, subsequent to the first input data signal among the plurality of input data signals IDAT, using at least one of the initial sensing data FDATA and the existing sensing data BDATA on the basis of the drive time of the display device 10, thereby generating first compensation data. The data driver 120 may sense the pixel current flowing in the plurality of pixels as the data voltage corresponding to the first compensation data is applied to the plurality of pixels, and generate second sensing data on the basis of the pixel current. The timing controller 100 may compensate a third input data signal subsequent to the second input data signal by determining one of the initial sensing data FDATA and the existing sensing data BDATA as a comparison target and comparing the second sensing data with the comparison target, thereby generating second compensation data.

The timing controller 100 may include a temperature compensator 150. The temperature compensator 150 may compensate an input data signal IDAT on the basis of the sensing data SDATA. The temperature compensator 150 may compensate an input data signal IDAT, selectively using the initial sensing data FDATA or the existing sensing data BDATA. The temperature compensator 150 may generate compensation data DATA by compensating an input data signal IDAT.

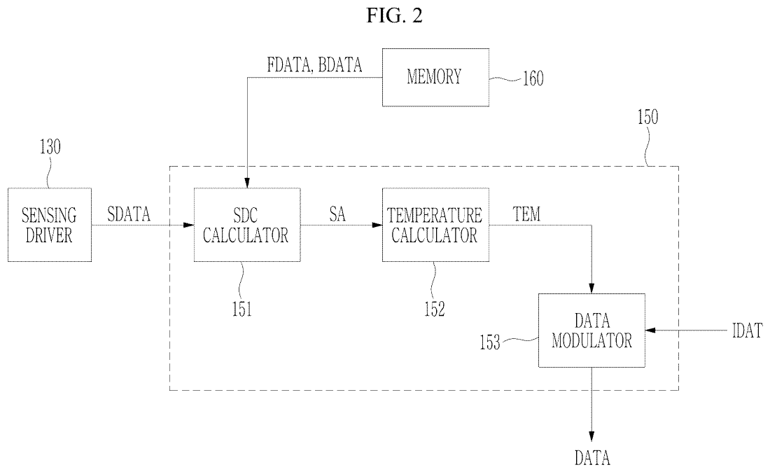

FIG. 2 is a view illustrating some components of the display device according to an embodiment.

Referring to FIG. 2, the temperature compensator 150 may include a sensing data change (SDC) calculator 151, a temperature calculator 152, and a data modulator 153.

The SDC calculator 151 may receive the sensing data SDATA from the sensing driver 130. The SDC calculator 151 may read at least one of the initial sensing data FDATA and the existing sensing data BDATA from the memory 160. The SDC calculator 151 may calculate a sensing change SA on the basis of the initial sensing data FDATA or the existing sensing data BDATA. The sensing change SA may indicate the difference between the sensing data SDATA and the initial sensing data FDATA or the existing sensing data BDATA.

In the embodiment, the SDC calculator 151 may determine a comparison target for the sensing data SDATA, on the basis of the drive time of the display device 10, and generate the sensing change SA based on the comparison result. For example, when the drive time of the display device 10 is below a first threshold, the SDC calculator 151 may compare the sensing data SDATA and the initial sensing data FDATA. The SDC calculator 151 may calculate the difference between the sensing data SDATA and the initial sensing data FDATA as the sensing change SA. For example, when the drive time of the display device 10 is equal to or above the first threshold, the SDC calculator 151 may compare the sensing data SDATA and the existing sensing data BDATA. The SDC calculator 151 may calculate the difference between the sensing data SDATA and the existing sensing data BDATA as the sensing change SA. The SDC calculator 151 may transmit the sensing change SA to the temperature calculator 152.

The temperature calculator 152 may calculate a temperature change TEM on the basis of the sensing change SA. When the drive time of the display device 10 is below the first threshold, the temperature change TEM may be the difference between the temperature of the initial state of the display device 10 and the temperature of the current state of the display device. When the drive time of the display device 10 is equal to or above the first threshold, the temperature change TEM may be the difference between the temperature of the previous state of the display device 10 and the temperature of the current state of the display device.

When the drive time of the display device 10 is below a first threshold, the temperature change TEM may be a value determined mainly on the basis of an external factor. The external factor may be the temperature of the constituent elements disposed outside the display panel (reference symbol “140” in FIG. 1). When the drive time of the display device 10 is equal to or above the first threshold, the temperature change TEM may be a value determined on the basis of an internal factor. The internal factor may be the temperature of the display panel 140.

In the embodiment, the temperature calculator 152 may include a lookup table indicating the relationship between the sensing change SA and the temperature change TEM. The temperature calculator 152 may read the temperature change TEM, corresponding to the sensing change SA received from the SDC calculator 151, from the lookup table. In the embodiment, as the sensing change SA increases, the temperature change TEM may increase. However, the present disclosure is not limited thereto, and as the sensing change SA increases, the temperature change TEM may decrease, and the sensing change SA may vary with an arbitrary correction with the temperature change TEM. The temperature calculator 152 may transmit the temperature change TEM to the data modulator 153.

On the basis of the temperature change TEM, the data modulator 153 may determine a data compensation value corresponding to the temperature change TEM for compensating the input data signal IDAT to be written in the plurality of pixels (reference symbol “141” in FIG. 1). The data modulator 153 may compensate the input data signal IDAT on the basis of the data compensation value and output the compensation data DATA. In the embodiment, the data compensation value corresponding to the temperature change TEM may be set in advance. For example, a first compensation value may be set corresponding to a first temperature change, and a second compensation value may be set corresponding to a second temperature change. When the temperature change TEM indicates the first temperature change, the data modulator 153 may compensate the input data signal IDAT by the first compensation value, thereby generating the compensation data DATA. When the temperature change TEM indicates the second temperature change, the data modulator 153 may compensate the input data signal IDAT by the second compensation value, thereby generating the compensation data DATA.

Meanwhile, although not shown in FIG. 2, the memory 160 may also store a lookup table indicating the correspondence relationship between temperature changes TEM and data compensation values. The data modulator 153 may read the data compensation value corresponding to the temperature change TEM from the memory 160. The data modulator 153 may compensate the input data signal IDAT on the basis of the data compensation value and output the compensation data DATA.

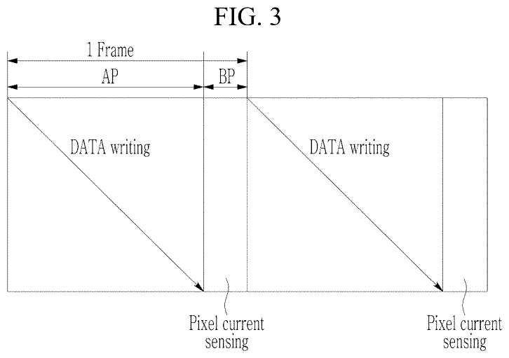

FIG. 3 is a view illustrating a frame of the display device according to an embodiment.

Referring to FIG. 3, a frame may include a vertical active period AP and a vertical blank period BP. The vertical active period AP may be a period when the data transmission signals (reference symbols “D1, D2, D3, . . . , Dn-1, and Dn” in FIG. 1) are transferred to the plurality of pixels (reference symbol “141” in FIG. 1). The vertical blank period BP may be a period when transfer of the data transmission signals D1, D2, D3, . . . , Dn-1, and Dn to the plurality of pixels 141 stops. In other words, the vertical blank period BP may be a period when the display device (reference symbol “10” in FIG. 1) does not display the image. In the embodiment, the display device 10 may perform a sensing mode in the vertical blank period BP. The sensing driver (reference symbol “130” in FIG. 1) may sense the pixel current in the vertical blank period BP in a frame. The sensing driver 130 may generate sensing data on the basis of the mobility of the driving transistor included in each of the plurality of pixels 141 in the vertical blank period BP.

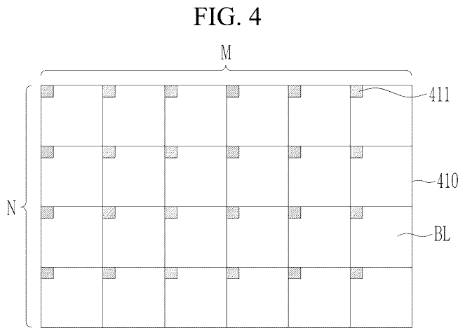

FIG. 4 is a view illustrating a display panel according to an embodiment.

Referring to FIG. 4, a display panel 410 may include a plurality of blocks BL. The plurality of blocks BL may be arranged in N-number of rows and M-number of columns. The plurality of pixels (reference symbol “141” in FIG. 1) may be grouped into the plurality of blocks BL. In the embodiment, each of the plurality of blocks BL may include representative pixels 411. The representative pixels 411 may be at least one of the plurality of pixels (reference symbol “141” in FIG. 1) included in the block BL.

The sensing driver (reference symbol “130” in FIG. 1) may receive the sensing signals S1, S2, S3, . . . , Sn-1, and Sn through the sensing lines SL1, SL2, SL3, . . . , SLn-1, and SLn connected to the plurality of representative pixels 411 among the plurality of sensing lines (reference symbols “SL1, SL2, SL3, . . . , SLn-1, and SLn” in FIG. 1). The sensing driver 130 may perform analog-to-digital conversion on the sensing signals S1, S2, S3, . . . , Sn-1, and Sn, thereby generating the sensing data SDATA. When the sensing driver 130 senses the pixel current only with respect to the plurality of representative pixels 411, the display device 10 can be driven at low power as compared to the case of sensing the pixel current with respect to all of the plurality of pixels 141.

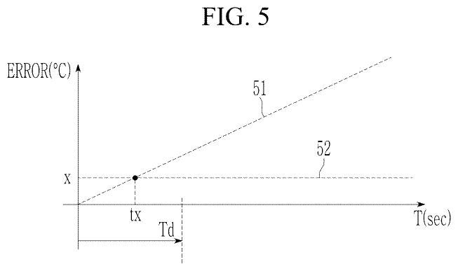

FIG. 5 is a graph illustrating temperature error according to the drive time of the display device according to an embodiment.

Referring to FIG. 5, a first temperature error graph 51 is a graph representing the temperature error of the display device 10 depending on the drive time of the display device (reference symbol “10” in FIG. 1). The first temperature error graph 51 may represent the difference between the temperature of the display device 10 due to deterioration of the display panel (reference symbol “140” in FIG. 1) and the temperature of the ideal display device 10 in which the display panel 140 has not deteriorated.

Deterioration of the display panel 140 may increase in proportion to the drive time Td of the display device 10. For example, as the drive time Td of the display device 10 becomes longer, deterioration of performance of the elements included in the pixels (reference symbol “141” in FIG. 1), such as the driving transistors and the OLEDs, may occur. For example, as the drive time Td of the display device 10 becomes longer, heat may be generated inside the display panel 140, resulting in an increase in thermal stress.

The temperature change (reference symbol “TEM” in FIG. 2) calculated by the temperature calculator (reference symbol “152” in FIG. 2) due to the deterioration of the display panel 140 may refer to the difference between the temperature of the display device 10 due to the deterioration of the display panel 140 and the temperature of the temperature of the ideal display device 10 in which the display panel 140 has not deteriorated. The temperature change (reference symbol “TEM” in FIG. 2) which is calculated by the temperature calculator (reference symbol “152” in FIG. 2) due to the deterioration of the display panel 140 may increase as the drive time Td of the display device 10 becomes longer.

A second temperature error graph 52 is a graph representing the temperature error of the display device 10 depending on the drive time Td of the display device 10. The second temperature error graph 52 may represent the difference between the temperature of the display device 10 due to deterioration of the constituent elements disposed outside the display panel 140 and the temperature of the ideal display device 10 in which the constituent elements disposed outside the display panel 140 have not deteriorated.

The plurality of pixels 141 included in the display panel 140 may be continuously exposed to voltage and current. The display panel 140 may be made of a thin and flexible material, and thus may be susceptible to deterioration. In contrast, the timing controller 100 and the PCB substrate may be made of thick and rigid materials since their main purpose is electrical signal transfer. The timing controller 100 and the PCB substrate may be more resistant to deterioration than the display panel 140. Accordingly, the second temperature error graph 52 may have less volatility depending on the drive time Td of the display device 10 than the first temperature error graph 51.

When the drive time Td of the display device 10 is a first threshold tx, the first temperature error graph 51 and the second temperature error graph 52 may intersect each other. At the first threshold tx, in each of the first temperature error graph 51 and the second temperature error graph 52, the temperature change TEM calculated by the temperature calculator 152 may be X (in ° C.).

When the drive time Td is below the first threshold tx, the SDC calculator (reference symbol “151” in FIG. 2) may calculate the difference between the sensing data (reference symbol “SDATA” in FIG. 2) and the initial sensing data (reference symbol “FDATA” in FIG. 2) as the sensing change (reference symbol “SA: in FIG. 2). The SDC calculator 151 may transmit the sensing change SA to the temperature calculator (reference symbol “152” in FIG. 2). The temperature calculator 152 may read the temperature change TEM, corresponding to the sensing change SA received from the SDC calculator 151, from the lookup table. The temperature calculator 152 may transmit the temperature change TEM, read from the lookup table, to the data modulator (reference symbol “153” in FIG. 2). The temperature change TEM which the temperature calculator 152 transmits to the data modulator 153 may be a value determined on the basis of an external factor. The external factor may be the temperature of the constituent elements disposed outside the display panel. On the basis of the temperature change TEM, the data modulator 153 may compensate the input data signal IDAT to be written in the plurality of pixels 141.

When the drive time Td is equal to or above the first threshold tx, the SDC calculator 151 may calculate the difference between the sensing data SDATA and the existing sensing data (reference symbol “BDATA” in FIG. 2) as the sensing change SA. The SDC calculator 151 may transmit the sensing change SA to the temperature calculator 152. The temperature calculator 152 may read the temperature change TEM, corresponding to the sensing change SA received from the SDC calculator 151, from the lookup table. The temperature calculator 152 may transmit the temperature change TEM, read from the lookup table, to the data modulator 153. The temperature change TEM which the temperature calculator 152 transmits to the data modulator 153 may be a value determined on the basis of an internal factor. The internal factor may be the temperature of the display panel 140. On the basis of the temperature change TEM, the data modulator 153 may compensate the input data signal IDAT to be written in the plurality of pixels 141.

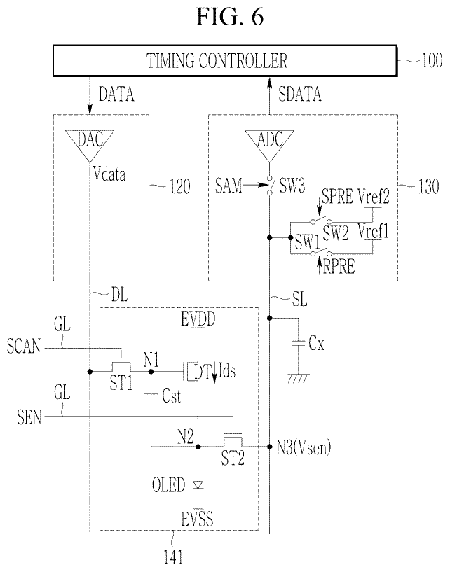

FIG. 6 is a circuit diagram illustrating a timing controller, a data driver, a sensing driver, and a pixel according to an embodiment.

Referring to FIG. 6, the data driver 120 may include a digital-to-analog converter DAC connected to a data line DL of the display panel (reference symbol “140” in FIG. 1). The sensing driver 130 may include an analog-to-digital converter ADC connected to a sensing line SL of the display panel 140, a first switch SW1 that controls the electrical connection between a first reference voltage source Vref1 and the sensing line SL, a second switch SW2 that controls the electrical connection between a second reference voltage source Vref2 and the sensing line SL, and a third switch SW3 that controls the electrical connection between the analog-to-digital converter ADC and the sensing line SL. As described above, the sensing driver 130 may generate a first switch control signal RPRE, a second switch control signal SPRE, and a third switch control signal SAM on the basis of the sensing timing control signal (reference symbol “SC:” in FIG. 1). In response to the first switch control signal RPRE, the first switch SW1 may be turned on or off. In response to the second switch control signal SPRE, the second switch SW2 may be turned on or off. In response to the third switch control signal SAM, the third switch SW3 may be turned on or off.

A pixel 141 may include an OLED, a driving transistor DT, a storage capacitor Cst, a first switch transistor ST1, and a second switch transistor ST2. The OLED may include an anode electrode connected to a second node N2, a cathode electrode connected to a low-potential pixel power source EVSS, and an organic compound layer that is positioned between the anode electrode and the cathode electrode. The driving transistor DT may include a gate electrode connected to a first node N1, a drain electrode connected to a high-potential pixel power source EVDD, and a source electrode connected to the second node N2.

The driving transistor DT may generate pixel current Ids according to the potential difference between the gate and the source and apply the pixel current to the OLED. The driving transistor DT may be turned on when the potential difference between the gate and the source is larger than the threshold voltage of the driving transistor DT. The pixel current Ids may be applied to the OLED through the driving transistor DT turned on. As the pixel current Ids increases, the amount of light which the OLED emits may increase.

The storage capacitor Cst may be connected between the first node N1 and the second node N2. The storage capacitor Cst may maintain the potential difference between the gate and source of the driving transistor DT for a predetermined time.

The first switch transistor ST1 may include a gate electrode connected to a gate line GL, a drain electrode connected to the data line DL, and a source electrode connected to the first node N1. The first switch transistor ST1 may be switched in response to a scan signal SCAN, thereby applying data voltage Vdata, charged in the data line DL, to the first node N1. The data voltage Vdata may be a voltage corresponding to each of the data transmission signals (reference symbols “D1, D2, D3, . . . , Dn-1, and Dn” in FIG. 1), and may be transferred to the plurality of data lines (reference symbols “DL1, DL2, DL3, . . . , DLn-1, and DLn” in FIG. 1). The scan signal SCAN may be a sequential (row-by-row) row selection signal for the gate driver (reference symbol “110” in FIG. 1) to control driving of the plurality of pixels 141.

The gate electrode of the second switch transistor ST2 may be connected to the gate line GL. The drain electrode of the second switch transistor ST2 may be connected to the second node N2. The source electrode of the second switch transistor ST2 may be connected to the sensing line SL. The second switch transistor ST2 may be switched in response to a gate sensing signal SEN, thereby electrically connecting the second node N2 and the sensing line SL. The gate sensing signal SEN may be a signal for the gate driver 110 to sense the states of the plurality of pixels 141. The gate sensing signal SEN may be a row selection signal for selecting a specific pixel which needs to be subjected to state sensing among the plurality of pixels 141.

In an initialization period, the first switch transistor ST1 may be turned on in response to the gate signal (SCAN) at the on level. The second switch transistor ST2 may be turned on in response to the gate sensing signal SEN at the on level. The first switch SW1 may be turned on in response to the first switch control signal RPRE at the on level. To the first node N1, the data voltage Vdata may be applied. To the second node N2, a first reference voltage Vref1 may be applied. The potential difference Vgs between the gate and source of the driving transistor DT may be set to a value higher than the threshold voltage of the driving transistor DT.

In a programming period, the first switch transistor ST1 may be turned off in response to the gate signal (SCAN) at the off level. The second switch transistor ST2 may be turned on in response to the gate sensing signal SEN at the on level. The second switch SW2 may be turned on in response to the second switch control signal SPRE at the on level. The potential of the second node N2 may be lowered from the first reference voltage Vref1 to a second reference voltage Vref2. Due to the coupling effect, the potential of the first node N1 may also be lowered by Vref1 Vref2. The potential difference Vgs between the gate and source of the driving transistor DT may be maintained at the level set in the initialization period.

In a sensing period, pixel current may flow between the drain and source of the driving transistor DT. By the pixel current, the potential of the second node N2 may be raised. The second switch SW2 may be turned off in response to the second switch control signal SPRE at the off level. The sensing line SL connected to the second node N2 through a third node N3 may be floated for the sensing period. The potential of the sensing line SL may also increase, similar to the second node N2.

In the sampling period, the third switch SW3 may be turned on in response to the third switch control signal SAM at the on level, such that the sensing line SL is connected to the analog-to-digital converter ADC. The charging voltage Vsen of the sensing line SL may be applied as a sensing value to the analog-to-digital converter ADC. The analog-to-digital converter ADC may perform analog-to-digital conversion on the sensing value, and output the sensing data SDATA.

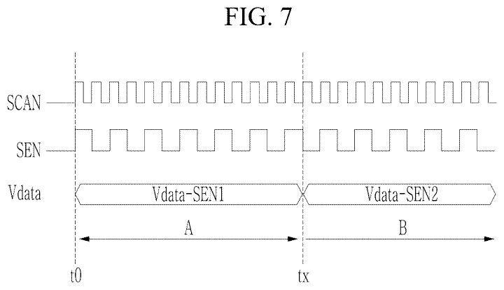

FIG. 7 is a timing diagram illustrating a change in data voltage, which is applied to a gate of a driving transistor, depending on a drive time according to an embodiment.

Referring to FIG. 7, the scan signal SCAN may be a pulse-type signal having a predetermined period and duration, and be enabled for a specific time such that a signal for selecting a row is transmitted to a plurality of pixels. The gate sensing signal SEN may be a pulse-type signal having a predetermined period and duration, and be enabled for a specific time such that a signal for sensing the state of a row is transmitted to a plurality of pixels. Although the scan signal SCAN and the gate sensing signal SEN have been described as pulse-type signals having predetermined periods and durations for ease of explanation, the present disclosure is not limited thereto.

The process of compensating an input data signal IDAT may vary depending on the drive time of the display device (reference symbol “10” in FIG. 1). For ease of explanation, the drive time (reference symbol “Td” in FIG. 5) of the display device 10 below the first threshold tx is assumed to be a first period A, and the drive time Td of the display device 10 equal to or above the first threshold tx is assumed to be a second period B.

In the first period A, the SDC calculator (reference symbol “151” in FIG. 2) may calculate the difference between the existing sensing data (reference symbol “BDATA” in FIG. 2) and the initial sensing data (reference symbol “FDATA” in FIG. 2) as the sensing change (reference symbol “SA” in FIG. 2). The SDC calculator 151 may transmit the sensing change SA to the temperature calculator (reference symbol “152” in FIG. 2). The temperature calculator 152 may transmit the temperature change TEM, corresponding to the sensing change SA received from the SDC calculator 151, to the data modulator (reference symbol “153” in FIG. 2). The temperature change TEM which the temperature calculator 152 transmits to the data modulator 153 may be a value determined mainly on the basis of an external factor. The external factor may be the temperature of the constituent elements disposed outside the display panel (reference symbol “140” in FIG. 1). On the basis of the temperature change TEM, the data modulator 153 may compensate the input data signal IDAT to be written in the plurality of pixels 141. The data modulator 153 may output the compensation data DATA obtained by compensating the input data signal IDAT. The data driver may output VSEN1 as the data voltage Vdata by performing digital-to-analog conversion on the compensation data DATA.

In the second period B, the SDC calculator 151 may calculate the difference between the sensing data SDATA and the existing sensing data (reference symbol “BDATA” in FIG. 2) as the sensing change SA. The SDC calculator 151 may transmit the sensing change SA to the temperature calculator 152. The temperature calculator 152 may transmit the temperature change TEM, corresponding to the sensing change SA received from the SDC calculator 151, to the data modulator 153. The temperature change TEM which the temperature calculator 152 transmits to the data modulator 153 may be a value determined on the basis of an internal factor. The internal factor may be the temperature of the display panel 140. On the basis of the temperature change TEM, the data modulator 153 may compensate the input data signal IDAT to be written in the plurality of pixels 141. The data modulator 153 may output the compensation data DATA obtained by compensating the input data signal IDAT. The data driver may output VSEN2 as the data voltage Vdata by performing digital-to-analog conversion on the compensation data DATA.

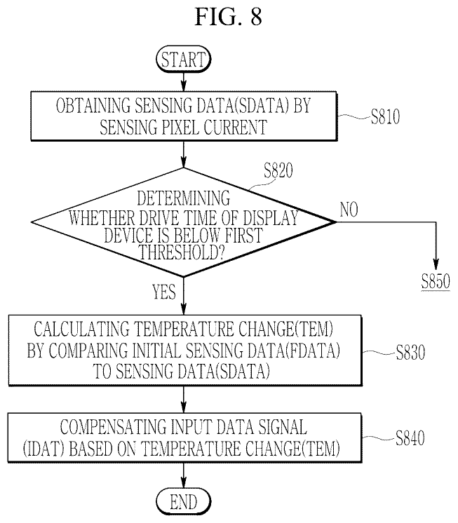

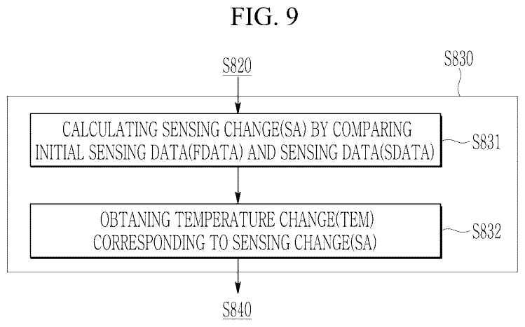

FIG. 8 is a flow chart illustrating an embodiment of a method of driving the display device according to an embodiment. FIG. 9 is a flow chart illustrating STEP S830 of FIG. 8.

The display device (reference symbol “10” in FIG. 1) may obtain the sensing data SDATA by sensing the pixel current (S810). In this case, the pixel current may refer to current which flows in the plurality of pixels when the display device 10 sequentially receive a plurality of input data signals and a data voltage corresponding to a first input data signal of the plurality of input data signals is applied to a plurality of pixels (reference symbol “141” in FIG. 1). The current flowing in the plurality of pixels 141 may refer to current flowing in the driving transistors (reference symbol “DT” in FIG. 6) included in the pixels 141. However, this is merely an example, and the display device 10 may sense the source voltage of a driving transistor DT in place of the pixel current.

The display device 10 determines whether the drive time (reference symbol “Td” in FIG. 5) of the display device 10 is below the first threshold (reference symbol “tx” in FIG. 5) (S820). When the drive time of the display device 10 is equal to or above the first threshold tx, the display device 10 performs STEP S850. The display device 10 may compensate the input data signal IDAT using the existing sensing data (reference symbol “BDATA” in FIG. 1). When the drive time of the display device 10 is below the first threshold tx, the display device 10 may compensate the input data signal IDAT using the initial sensing data (reference symbol “FDATA” in FIG. 1).

The display device 10 may calculate the temperature change TEM by comparing the initial sensing data FDATA and the sensing data SDATA (S830). The temperature change TEM may be the difference between the temperature of the initial state of the display device 10 and the temperature of the current state of the display device.

Referring to FIG. 9 together, the display device 10 may calculate the sensing change SA by comparing the initial sensing data FDATA and the sensing data SDATA (S831). The display device 10 may calculate the difference between the sensing data SDATA and the initial sensing data FDATA as the sensing change SA.

The display device 10 may obtain the temperature change TEM corresponding to the sensing change SA, with reference to a first lookup table (S832). The temperature change TEM may be a value determined mainly on the basis of an external factor. The external factor may be the temperature of the constituent elements disposed outside the display panel (reference symbol “140” in FIG. 1). For example, the external factor may be temperature attributable to the timing controller 100, the printed circuit board (PCB) substrate, and so on.

The display device 10 may compensate the input data signal IDAT on the basis of the temperature change TEM (S840). The display device 10 may generate the compensation data DATA by compensating the input data signal IDAT.

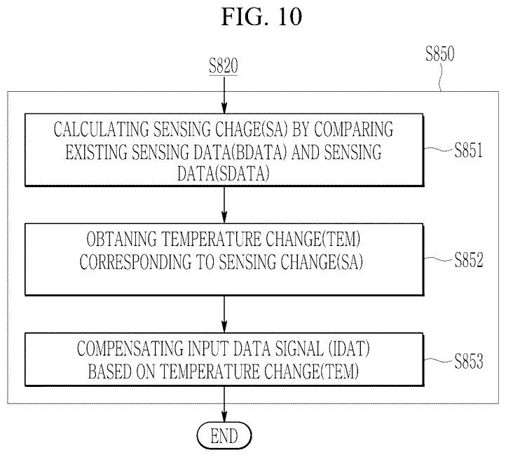

FIG. 10 is a flow chart illustrating STEP S850 of FIG. 8.

The display device (reference symbol “10” in FIG. 1) may calculate the sensing change SA by comparing the existing sensing data BDATA and the sensing data SDATA (S851). The display device 10 may calculate the difference between the existing sensing data BDATA and the sensing data SDATA as the sensing change SA. The sensing data SDATA may be generated on the basis of the first compensation data generated by compensating the second input data signal subsequent to the first input data signal among the plurality of input data signals. To the plurality of pixels, the data voltage corresponding to the first compensation data may be applied. By sensing the pixel current flowing in the plurality of pixels, the sensing data SDATA may be generated.

The display device 10 may obtain the temperature change TEM corresponding to the sensing change SA, with reference to a first lookup table (S852). The temperature change TEM may be a value determined on the basis of an internal factor. The internal factor may be the temperature of the display panel 140.

The display device 10 may compensate the input data signal IDAT on the basis of the temperature change TEM (S853). The display device 10 may generate the compensation data DATA by compensating the input data signal IDAT.

The display device 10 according to the embodiment may be applied to various electronic devices. An electronic device according to an embodiment may include the above-described display device 10, and may further include a module or a device having an additional different function besides in addition to the display device 10.

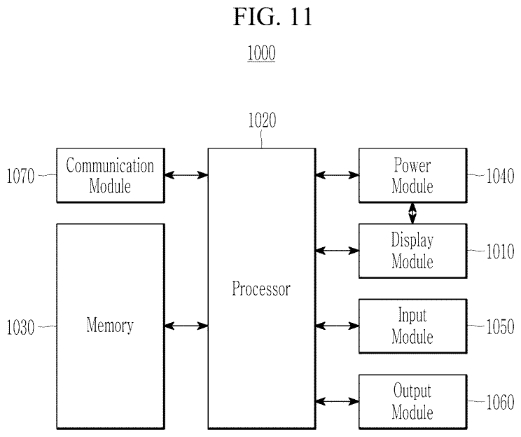

FIG. 11 is a block diagram of an electronic device according to an embodiment.

Referring to FIG. 11, an electronic device 1000 may include a display module 1010, a processor 1020, a memory 1030, and a power module 1040. The electronic device 1000 may further include an input module 1050, a non-image output module 1060, and/or a communication module 1070.

The electronic device 1000 may output various information in the form of an image through the display module 1010. When the processor 1020 may execute an application stored in the memory 1030, image information which is provided by the application may be provided to a user through the display module 1010. In the memory 1030, the initial sensing data (reference symbol “FDATA” in FIG. 1) and the existing sensing data (reference symbol “BDATA” in FIG. 1) may be stored. The initial sensing data FDATA may be sensing data SDATA which the display module 1010 outputs by the data signals D1, D2, D3, . . . , Dn-1, and Dn in the state where the environmental temperature of the display module 1010 has been set in advance. The environmental temperature may refer to the temperature of the external constituent elements of the display module 1010. The existing sensing data BDATA may be sensing data SDATA which the display module 1010 outputs with respect to the previous frame.

The processor 1020 according to the embodiment may read the initial sensing data FDATA and the existing sensing data BDATA from the memory 1030. The processor 1020 may provide the initial sensing data FDATA and the existing sensing data BDATA to the display module 1010. The processor 1020 may be implemented as one or more processors.

The processor 1020 according to the embodiment may transmit the vertical synchronization signal (reference symbol “Vsync” in FIG. 1), the horizontal synchronization signal (reference symbol “Hsync” in FIG. 1), the data enable signal (reference symbol “DE” in FIG. 1), and the input data signal (reference symbol “IDAT” in FIG. 1) to the display module 1010. The display module 1010 may perform the normal mode or the sensing mode on the basis of the vertical synchronization signal Vsync, the horizontal synchronization signal Hsync, and the data enable signal DE. In the normal mode, the display module 1010 may apply the data signals (reference symbols “D1, D2, D3, . . . , Dn-1, and Dn” in FIG. 1) to the plurality of pixels included in the display module 1010. In the sensing mode, the display module 1010 may generate the compensation data (reference symbol “DATA” in FIG. 1) by compensating image data corresponding to the input data signal IDAT.

The display module 1010 according to the embodiment may be the display device 10 described with reference to FIGS. 1 to 10. The display module 1010 may generate the compensation data DATA by compensating the image data, corresponding to the input data signal IDAT, using the initial sensing data FDATA or the existing sensing data BDATA. For example, when the drive time (reference symbol “Td” in FIG. 5) of the electronic device 1000 is below the first threshold (reference symbol “tx” in FIG. 5), the display module 1010 may generate the compensation data DATA using the initial sensing data FDATA. When the drive time Td of the electronic device 1000 is equal to or above the first threshold tx, the display module 1010 may generate the compensation data DATA using the existing sensing data BDATA. Since the display module 1010 compensates the input data signal IDAT depending on the drive time Td of the electronic device 1000, the display module 100 can implement uniform luminance.

According to another embodiment, the display module 1010 may read the initial sensing data FDATA and the existing sensing data BDATA from the memory 1030. The display module 1010 may generate compensation data DATA by compensating the image data corresponding to the input data signal IDAT on the basis of the initial sensing data FDATA or the existing sensing data BDATA.

The power module 1040 may include a power supply module such as a power adapter or a battery device, and a power conversion module that converts the power supplied by the power supply module to generate power required for the operation of the electronic device 1000. The input module 1050 may provide input information to the processor 1020 and/or the display module 1010. The non-image output module 1060 may serve to receive information other than images received from the processor 1020, for example, information such as sound information, haptic information, and light emission information, and provide the information to the user. The communication module 1070 may be a module which is in charge of transmission and reception of information between the electronic device 1000 and an external device, and may include a receiver and a transmitter.

At least one of the individual components of the electronic device 1000 described above may be included in the display device (reference symbol “10” in FIG. 1) according to the above-described embodiments. Further, some of the individual modules that are functionally included in a module may be included in the display device 10, and others may be provided separately from the display device 10. For example, the display device 10 may include the display module 1010, and the processor 1020, the memory 1030, and the power module 1040 may be provided in the form of another device in the electronic device 1000 rather than the display device.

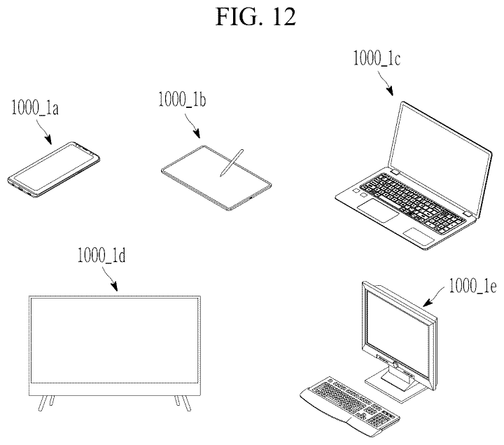

FIGS. 12 to 14 are schematic diagrams of electronic devices according to various embodiments.

FIG. 12 illustrates a smart phone 1000_1a, a tablet PC 1000_1b, a laptop 1000_1c, a TV set 1000_1d, and a desktop monitor 1000_1e as examples of the electronic device (reference symbol “1000” in FIG. 11).

The smart phone 1000_1a may include the input module (reference symbol “1050” in FIG. 11) such as a touch sensor and the communication module (reference symbol “1070” in FIG. 11) in addition to the display module (reference symbol“1010” in FIG. 11). The smart phone 1000_1a may process information received through the communication module 1070 or another input module 1050, and display the information through the display module (reference symbol “1010” in FIG. 11) of the display device 10.

The tablet PC 1000_1b, the laptop 1000_1c, the TV set 1000_1d, and the desktop monitor 1000_1e may also include the display module 1010 and the input module 1050 similar to the smart phone 1000_1a, and may further include the communication module 1070 in some cases.

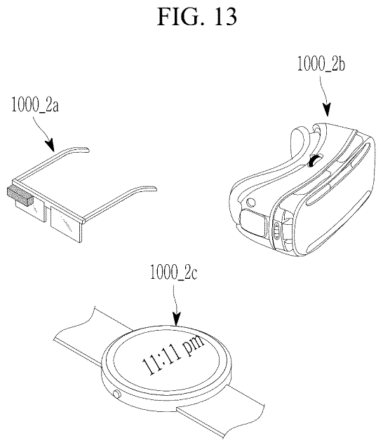

FIG. 13 illustrates the case where the electronic device including the display module is applied to a wearable electronic device. The wearable electronic device may be smart spectacles 1000_2a, head-mounted display 1000_2b, a smart watch 1000_2c, etc.

The smart spectacles 1000_2a and the head-mounted display 1000_2b may include the display module (reference symbol “1010” in FIG. 11) that projects a display screen, and a reflector that reflects a projected display screen, thereby providing the display screen to the eyes of a user, such that virtual reality or augmented reality can be provided to the user.

The smart watch 1000_2c may include a biometric sensor as an input device, and provide biometric information recognized by the biometric sensor to a user via the display module 1010.

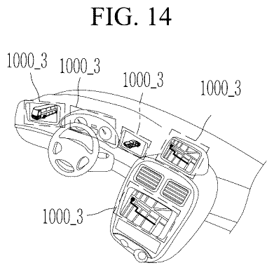

FIG. 14 illustrates the case where the electronic device including the display module is applied to a vehicle. For example, an electronic device 1000_3 may be applied to the instrument panel, center fascia, etc., of an automobile, or may be applied to a center information display (CID) placed on the dashboard of an automobile, to a room mirror display that replaces a side mirror, etc.

While the present disclosure has been described with reference to embodiments thereof, it will be apparent to those of ordinary skill in the art that various changes and modifications may be made thereto without departing from the scope and spirit of the present disclosure as set forth in the following claims.

What is claimed is:

1. A display device comprising:
a display panel including a plurality of pixels;
a data driver configured to receive sequentially a plurality of input data signals, and apply data voltages, corresponding to a first input data signal of the plurality of input data signals, to the plurality of pixels;
a sensing driver configured to sense pixel current flowing in the plurality of pixels as the data voltages are applied to the plurality of pixels, and generate first sensing data on a basis of the pixel current; and
a timing controller configured to generate first compensation data by compensating a second input data signal, subsequent to the first input data signal among the plurality of input data signals, using at least one of initial sensing data and the first sensing data on a basis of a drive time of the display device.

2. The display device of claim 1, wherein:
the data driver is further configured to sense pixel current flowing in the plurality of pixels as the data voltage corresponding to the first compensation data is applied to the plurality of pixels, and generate second sensing data on the basis of the pixel current.

3. The display device of claim 2, wherein:
the timing controller is further configured to generate second compensation data by determining one of the initial sensing data and the first sensing data as a comparison target, and compensating a third input data signal subsequent to the second input data signal by comparing the second sensing data with the comparison target.

4. The display device of claim 3, wherein:
the initial sensing data is sensing data which the sensing driver is further configured to generate as an external environmental temperature of the display panel is set to a predetermined value and a preset data signal is applied to the plurality of pixels.

5. The display device of claim 3, further comprising:
a memory configured to store the initial sensing data and the first sensing data.

6. The display device of claim 3, wherein:
the timing controller includes the following:
a sensing data change calculator configured to calculate a difference between the initial sensing data or the first sensing data and the second sensing data as a sensing change;
a temperature calculator configured to read a temperature change, corresponding to the sensing change, from a lookup table; and
a data modulator configured to generate the second compensation data on the basis of the temperature change read from the lookup table.

7. The display device of claim 6, wherein:
the sensing data change calculator is further configured to calculate a first sensing change using the difference between the initial sensing data and the second sensing data, when the drive time of the display device is below a first threshold, and calculate a second sensing change using the difference between the first sensing data and the second sensing data, when the drive time of the display device is equal to or above the first threshold.

8. The display device of claim 7, wherein:
the temperature calculator is further configured to perform the following:
when the drive time of the display device is below the first threshold, reading a first temperature change, corresponding to the first sensing change, from the lookup table, the first temperature change indicating a difference between a first temperature of the display device attributable to deterioration of constituent elements disposed outside the display panel and a second temperature of the ideal display device in which constituent elements disposed outside the display panel have not deteriorated;
when the drive time of the display device is equal to or above the first threshold, reading a second temperature change, corresponding to the second sensing change, from the lookup table, the second temperature change indicating a difference between a third temperature of the display device attributable to deterioration of the display panel and a fourth temperature of the ideal display device in which the display panel has not deteriorated.

9. The display device of claim 8, wherein:
the data modulator is further configured to compensate the third input data signal on the basis of a first data compensation value corresponding to the first temperature change, when the drive time of the display device is below the first threshold, and compensate the third input data signal on the basis of a second data compensation value corresponding to the second temperature change, when the drive time of the display device is equal to or above the first threshold.

10. The display device of claim 9, wherein:
the first threshold is determined on the basis of the drive time of the display device when the difference between the first temperature and the second temperature, and the difference between the third temperature and the fourth temperature becomes the same.

11. The display device of claim 2, wherein:
in a vertical blank period when writing of a data transmission signal corresponding to the first compensation data is stopped, the sensing driver is further configured to generate the second sensing data on the basis of an electron mobility of a driving transistor included in each of the plurality of pixels.

12. The display device of claim 11, wherein:
the plurality of pixels is grouped into a plurality of blocks, and each of the plurality of blocks includes at least one representative pixel, and
the sensing driver is further configured to generate the second sensing data on the basis of the electron mobility of the driving transistor in the at least one representative pixel.

13. The display device of claim 1, wherein:
the timing controller is disposed outside the display panel.

14. The display device of claim 1, wherein:
the display panel includes a heat shielding film, and transfer of heat which is generated from outside the display panel is blocked by the heat shielding film.

15. A method of driving a display device, comprising:
receiving sequentially a plurality of input data signals and applying data voltages, corresponding to a first input data signal of the plurality of input data signals, to a plurality of pixels;
generating first sensing data by sensing pixel current flowing in a driving transistor included in each of the plurality of pixels; and
generating first compensation data by compensating a second input data signal, subsequent to the first input data signal among the plurality of input data signals, using at least one of initial sensing data and the first sensing data on a basis of a drive time of the display device.

16. The method of driving the display device according to claim 15, further comprising:
sensing pixel current flowing in the plurality of pixels as the data voltages corresponding to the first compensation data are applied to the plurality of pixels, and generating second sensing data on the basis of the pixel current.

17. The method of driving the display device according to claim 16, further comprising:
generating second compensation data by determining one of the initial sensing data and the first sensing data as a comparison target and compensating a third input data signal, subsequent to the second input data signal, by comparing the second sensing data with the comparison target.

18. The method of driving the display device according to claim 17, wherein:
the initial sensing data is sensing data which is generated as an external environmental temperature of the display panel is set to a predetermined value and a preset data signal is applied to the plurality of pixels.

19. The method of driving the display device according to claim 17, wherein:
generating the second compensation data includes:
calculating the difference between the initial sensing data or the first sensing data and the second sensing data as a sensing change;
reading a temperature change, corresponding to the sensing change, from a lookup table; and
generating the second compensation data on the basis of the temperature change read from the lookup table.

20. An electronic device comprising:
a display module configured to generate compensation data by compensating an input data signal using at least one of initial sensing data and existing sensing data on the basis of a drive time;
one or more processors configured to transmit an input data signal to the display module;
a memory that contains initial sensing data which is sensing data that the display module outputs in response to a preset data signal in a state in which an external environmental temperature of the display module is set to a predetermined value, and existing sensing data which is sensing data that the display module has output in a previous frame; and
a power module configured to supply power to the display module and the one or more processors.
